(19) United States
(12) Patent Application Publication
(10) Pub. No.: US 2022/0213276 A1
(43) Pub. Date: Jul. 7, 2022

(54) PROCESSES FOR BIOMASS TREATMENTS

(71) Applicant: POLITECNICO DI MILANO, Milano (Ml) (IT)

(72) Inventors: Andrea MELE, Milano (MI) (IT); Franca CASTIGLIONE, Saronno (VA) (IT); Monica FERRO, Milano (MI) (IT); Greta COLOMBO DUGONI, Inveruno (MI) (IT); Maria Enrica DI PIETRO, Sesto San Giovanni (MI) (IT); Alberto MANNU, Cusano Milanino (MI) (IT); Walter PANZERI, Barlassina (MB) (IT)

(21) Appl. No.: 17/612,994

(22) PCT Filed: May 19, 2020
(86) PCT No.: PCT/IB2020/054727

§ 371 Date: Nov. 19, 2021

(30) Foreign Application Priority Data
May 23, 2019 (IT) 102019000007175

(51) Int. Cl. C08H 8/00; D21C 3/20; C08L 5/14; C08L 97/00; D21C 9/08; D21C 1/10

(52) U.S. Cl. CPC C08H 8/00; D21C 3/20; D21C 1/10; C08L 97/005; D21C 9/086; C08L 5/14

(57) ABSTRACT

A process for treatment of lignocellulosic biomasses with a process solvent selected from an eutectic solvent consisting of a hydrogen bond acceptor and of a hydrogen bond donor, an ionic liquid, and a mixture of the eutectic solvent and the ionic liquid, may include: A. mixing the biomasses with the process solvent and possibly separating insoluble cellulose residues and/or inorganic material; B. treating the possibly filtered process solvent solution from step A with water, thereby separating lignin; and C. separating hemicellulose from the mixture of the process solvent and possibly the water. Step C may be carried out by adding an organic solvent soluble in the process solvent and in the water, whereby hemicellulose precipitates and is subsequently separated with conventional techniques from a liquid phase comprising the process solvent, the organic solvent, and possibly the water.

### FIELD OF THE INVENTION

The present invention relates to a treatment method for recovering lignocellulosic and possibly inorganic products from biomasses.

### BACKGROUND

The treatment of biomasses for obtaining high industrial value products is by all means a part of the concept of circular economy which provides for an economy intended to self-regenerate. In a circular economy the flows of materials are of two types: the biological ones, which are able to be reintegrated in the biosphere, and the technical ones, intended to be reused without entering in the biosphere.^{[1]}

For example, rice generates a great quantity of waste: for one ton of white rice 1.3 tons of straw, 200 kilograms of husk (often improperly defined as chaff)—the covering enclosing the grain—and 70 kilograms of chaff, the residue obtained from the rice bleaching, when the outer layer is removed from the grain, are produced.^{[2]} Such materials can hardly be burnt as they contain a remarkable quantity of silica that damages the combustion plants.^{[3]}

Another material whose processing wastes are of particular interest is thistle from which cellulose is extracted.^{[4,5]} Thistle is identified as a low-input crop which adapts well to the Mediterranean regions climate. Furthermore, thistle seeds are used to extract oil from which high added-value products are obtained such as for example azelaic acid and pelargonic acid.

A further example of a processing waste are wastes from beer processing also called brewers spent grains. They constitute about 85% of breweries wastes and the main components are cellulose (23-25%), hemicellulose (30-35%), lignin (11-27%) and proteins (15-24%).^{[6,7]}

From the biomass which represents the process waste lignin, hemicellulose and cellulose and possibly also silica can be extracted.

In particular, even though lignin constitutes from 20% to 30% of the earth plant biomass, the major problem is that it is difficult to separate it from the biomass. The known delignification process is in fact an expensive process. Lignin, normally considered as a problem in current processes for transforming plant biomasses, can on the contrary become the raw material for a series of industrial applications: vanillin production, the vanilla flavour used in the food, cosmetic and animal feed industries, and for producing fuel (ethanol, biodiesel). Thanks to its biodegradability and non-toxicity, lignin is exploited for producing granular soil improvers with micronutrients controlled release. Alternatively lignin can also be used as a dispersing agent in an aqueous medium, once oxidized or sulfonated, as a stabilizer in emulsions, a metal sequestering agent or a surfactant.

Silica, SiO₂, represents the real problem in the process of treating and reusing rice wastes. Such material is normally used as raw material for producing elemental silica, used for constructing printed circuit boards, transistors and other electronic components. Silica, having hardness 7 in the Mohs scale, is a relatively hard material, and it is therefore used as an abrasive. Silica can also be used in applications as an insulating material (for example it is also present in the heat shield of space probes or of the space shuttle), as refractory material used in furnaces, as a blend for modern tyres to reduce rolling resistance and improve wet grip, as an anti-caking agent in powder food and as an abrasive agent for the teeth surface in toothpastes. Other applications of silica include analytical chemistry, to separate compounds by means of chromatography, in the pharmaceutical industry as tablet filler and in the production of aerogel.

Regarding cellulose it is mainly used for producing paper. However, cellulose is also widely used in the pharmaceutical field (production of gauzes and coverings capable of modulating the active ingredients release from the tablet), cosmetic (gels, stabilizers, coatings, toothpastes), textile (rayon, lyocell), etcetera. Natural cellulose sponges can be used in many ways in the chemical sector: shipbuilding (to seal ducts in the bulkheads), petrochemical industry (filtration processes), cooling systems (humidity absorption), cloths for cleaning surfaces. Since cellulose is insoluble in water, it is transformed, through a chemical reaction, into CarboxyMethyl Cellulose (CMC) in order to be industrially exploited in some applications. This transformation occurs by introducing the carboxymethyl substituent which transforms cellulose, insoluble in organic solvents, into water-soluble CMC. CMC can be applied in many fields, especially thanks to its thickening ability (it increases viscosity in a solution) and floating ability (it keeps solid particles suspended in solution), in addition to its adhesive and water-retaining ability. The length of the CMC molecule (number of glucose units composing it) affects the solution viscosity and, therefore, the application field. The main CMC employment sectors are: cleansing, oil drillings, ceramics, paper chain, textile industry, coatings and paints, food industry, cosmetics, pharmaceutical and pet food. At industrial level high-crystalline cellulose (cellulose-free and therefore highly pure) is an important product in the food and pharmaceutical field.

Finally, hemicellulose which can hardly be separated from cellulose is used for producing furfural, which is used as a solvent in the petrochemical sector to extract dienes (as those used to produce synthetic rubber) from other hydrocarbons. Furfural can be employed for preparing solid resins, for producing glass fibres for aeronautics components and for brakes. It can also be used for producing Nylon, a process already implemented in the past, however, as it is difficult to separate it from hemicellulose, resulted industrially expensive with low yields as for the desired product.

They are known in the state of the art various processes for separating cellulosic material from the biomass by means of using eutectic solvents. For example, the most recent method of this kind is disclosed in WO 2017032926, which envisages the treatment of the biomass containing a certain quantity of hemicellulose, lignin or a combination thereof by adding a eutectic solvent. In particular, the eutectic solvents selected in this prior art are for example a combination of a salt of (2-R-etil)—trimethylammonium with boric acid, metaboric acid, boronic acid, borinic acid, alkyl borates, borate hydrate salts or puritic acid. The above described R group is selected from OH, halogens, ester groups, ether groups or carbamoyl. Furthermore, the mixture of biomass and solvent is added with a certain quantity of water at a temperature in a range between 40° C. and 100° C. Then, the aqueous mixture of the biomass is subdivided in a liquid fraction, a solid fraction and a fraction containing non-solubilized fibres. In particular, the liquid fraction contains hemicellulose and the eutectic solvent, while the solid fraction contains the precipitated lignin.

The above described known art has a number of problems, in that it does not allow the complete separation of elements constituting the biomass in particular lignin, hemicellulose and cellulose. Furthermore, this process does not allow the complete separation of the eutectic solvent from the reaction products; therefore recycling the used eutectic solvent is complicated.

### SUMMARY OF THE INVENTION

The Applicant found a method for the treatment of biomass able to overcome the drawbacks of the known art so as to allow processing biomass on a large and continuous scale allowing to obtain higher-degree purity end-products.

The object of the present invention is therefore a process for the treatment of lignocellulosic biomasses with a process solvent selected from a eutectic solvent consisting of a hydrogen bond acceptor and of a hydrogen bond donor, an ionic liquid and a mixture of said eutectic solvent and said ionic solvent, said process comprising the following steps:

A. mixing of the biomass with the process solvent and possibly separation of insoluble cellulose residues and/or inorganic material;
B. treatment of the process solvent solution with water and lignin separation;
C. separation of the hemicellulose from the mixture of process solvent and possibly from water;
wherein the step C of hemicellulose separation is carried out by adding an organic solvent that is soluble in the solvent and in water, thus allowing the precipitation of the hemicellulose and its subsequent separation with conventional techniques from the liquid phase comprising a process solvent, organic solvent and possibly water.

In particular, such process allows to easily and cost-effectively obtain high added-value products. Advantageously, the steps according to the present invention allow to separate with a high degree of purity biomass components, allowing at the same time a more efficient separation of the solvent initially used from the reaction mixture in order to be recycled in the process.

### LIST OF FIGURES

FIG. 1: Block diagram representing a process for the treatment of biomass according to a preferred embodiment of the present invention;

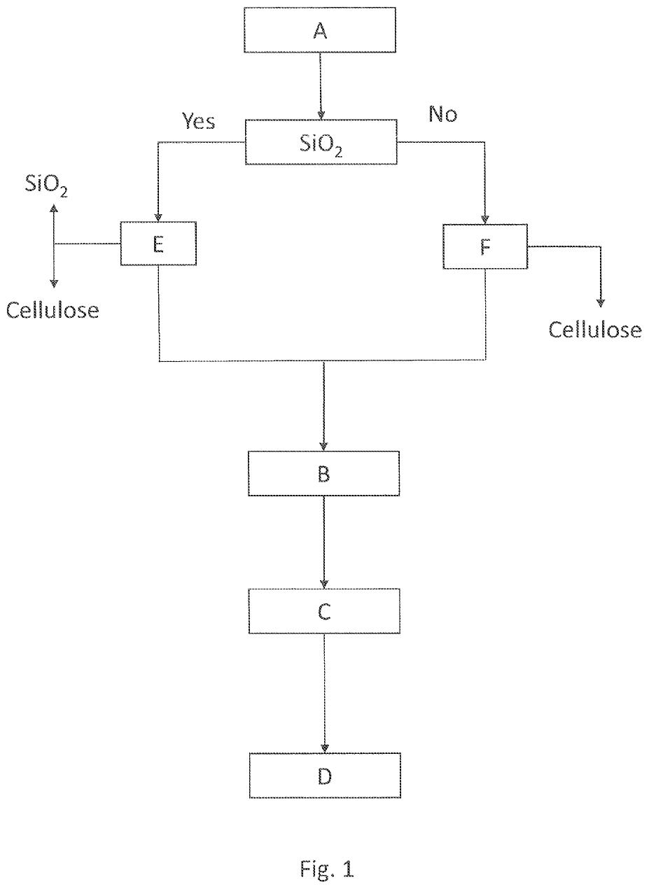

FIG. 2: Block diagram representing the process for the treatment of biomasses according to a further preferred embodiment of the present invention.

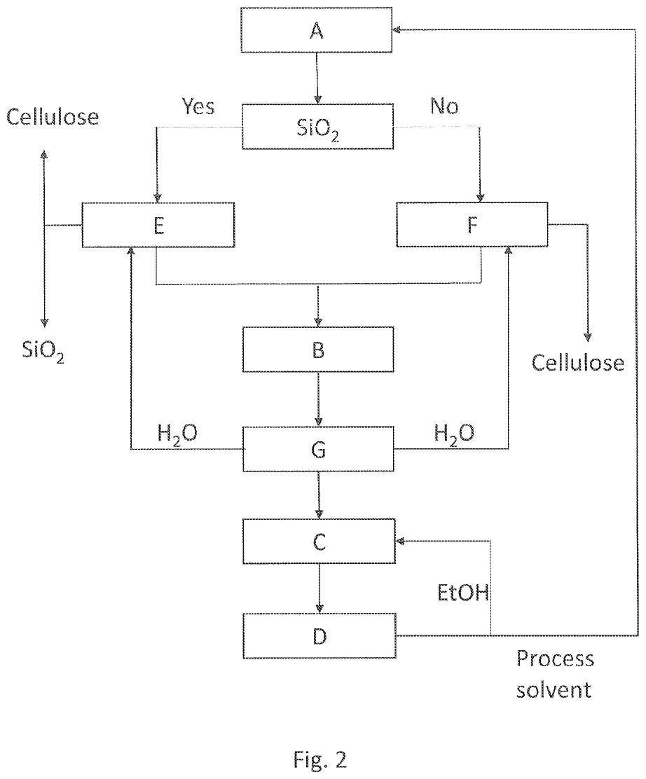

### DETAILED DESCRIPTION

For the purposes of the present invention lignocellulosic biomasses mean all the types of biomasses comprising at least hemicellulose, cellulose, lignin and optionally silica. Preferably, the lignocellulosic biomass is the totality of wastes from the processing steps for example of softwood, hardwood, straw, cane, hemp, sisal, flax, ramiè, jute, agave, kenaf, roselle, urena, acaba, coconut, corn, sugar cane, bagasse, banana, soy, palm oil, cotton, sugar beet, olives, grapes and fruit, rice, thistle, malt threshing wastes and combinations thereof. More preferably, the lignocellulosic biomass comprises rice processing wastes, such as for example husk and straw comprising a high percentage of silica, or vice versa of the silica-free thistle.

For the purposes of the present invention the process solvent can comprise a eutectic solvent, an ionic liquid or a combination of the eutectic solvent and ionic liquid.

For the purposes of the present invention eutectic solvents mean the so called deep eutectic solvents or DESs. In other words, it is a combination of a hydrogen bond acceptor and a hydrogen bond donor. Preferably the hydrogen bond acceptor is choline acetate, while the hydrogen bond donor is selected from glycolic acid, diglycolic acid, levulinic acid and imidazole. In a particularly preferred embodiment, the DES used is the combination of choline acetate and glycolic acid or choline acetate and levulinic acid.

For the purposes of the present invention, ionic liquid used as process solvent means the product resulting from the reaction of:

choline acetate+X—H=choline X⁻+CH₃COOH

where X is the anion of an organic weak acid preferably selected from glycolic acid, diglycolic acid and levulinic acid. In particular, the ionic liquid consists of a liquid system containing choline ions in presence of the conjugated base of the glycolic acid, or of the diglycolic acid or of the levulinic acid. In a particularly preferred embodiment, the ionic liquid used is composed of choline glycolate.

It must be noted that the reaction for producing ionic liquid is preferably carried out in a temperature range between 40 and 100° C., more preferably between 60 and 90° C., still more preferably between 70 and 85° C. and according to a particularly preferred embodiment at 80° C. Furthermore, the ratio between reactants is preferably 1:1.

Advantageously, as the process solvents used are halogen-free, they facilitate the disposal at industrial level.

Advantageously, the use of the above mentioned hydrogen bond acceptors and donors allow preparing DES by simply mixing the two components at room temperature and pressure reducing production costs and times thereof.

DESs can in turn react resulting into the above-mentioned ionic liquid. The fact that the reaction for forming the liquid is a balance reaction explains that the process liquid is a mixture of DES and ionic liquid.

According to the present invention the weight ratios between the eutectic solvent components, hydrogen bond donor and acceptor, are preferably comprised between 1:5 and 5:1, more preferably 1:3 to 3:1, still more preferably 1:2 to 2:1 and according to a particularly preferred solution said ratio is 1:1.

For the purposes of the present invention soluble organic solvent in the process solvent and in water means a polar solvent, preferably a protic polar solvent, still more preferably a linear or branched aliphatic alcohol C₁-C₆, in the most preferred case ethanol.

Advantageously, the soluble organic solvent added to a solution containing hemicellulose and the process solvent and optionally water promotes selective precipitation of the organic material, preferably of hemicellulose, allowing separation thereof and its use in following processing.

According to the present invention the organic solvent solubilizes the process solvent and optionally water promoting hemicellulose precipitation.

For the purposes of the present invention, the separation of the hemicellulose, which precipitates thanks to the addition of the organic solvent, preferably ethanol, is carried out by means of conventional procedures such as for example filtration, fractional precipitation, or, preferably, centrifugation.

An additional advantage of the invention is that the separation of the hemicellulose from the reaction mixture containing the process solvent, allows to obtain the same in a purer form. Thereby, the hemicellulose can be treated by conventional processes to give high added-value products such as furfural in excellent yields.

In Step A, mixing of the biomass with the process solvent preferably occurs in a range of temperature between 40 and 100° C., more preferably between 60 e 90° C. still more preferably between 70 e 85° C. and according to a particularly preferred embodiment at 80° C.

The processing process comprises a step that is prior to step A. wherein the biomass is ground and, in case the biomass has a high content of water, it is preferably dried. In particular, the grinding step reduces the biomass to be powder treated to a size distribution between 0.04 mm and 2 mm.

Advantageously, grinding the biomass facilitates the mixing with the process solvent, and the following separation steps.

Preferably, in step A. the possible separation of the insoluble cellulosic residues and/or inorganic material from the mixture containing the process solvent, is made by conventional procedures such as for example filtration, fractional precipitation, or, preferably, centrifugation.

The preparation process according to the present invention is used for the treatment of husk and/or rice straw. In this case, the biomass contains a high percentage of insoluble inorganic material in the process solvents, such as silica, and a percentage of soluble organic material in process solvents, such as cellulose. The process step A. according to the present invention provides the separation of the insoluble material in the process solvent of the mixture comprising the process solvent, hemicellulose and lignin. Thereby in step A. cellulose and silica separate from the rest of the mixture containing the process solvent.

In this case, the process comprises a step E. of separating cellulose from silica. Preferably, the step E. provide an initial step of washing the precipitate, comprising silica and cellulose, with water. In particular, the washing is repeated at least 1 to 10 times, preferably 6 times so as to promote removal of possible residues of the process solvent inside the mixture of silica and cellulose. Subsequently, the step E. provides the centrifugation of the aqueous mixture which provides obtaining three distinct steps: the heaviest step is the cellulose, the intermediate step is the silica and supernatant, the superficial step consists of water. Thereby, the process according to the invention allows to recover silica and cellulose from the biomass. Preferably, the washing water containing residues of the process solvent is used in the following step B.

By contrast, in case the biomass only contains insoluble cellulosic material in the process solvent, for example when the biomass comes from beer processing wastes, with threshing wastes, or from the thistle a step F. is carried out instead of step E. consisting in removing possible residues of the process solvent inside the cellulose coming from step A. by means of simply washing with water, repeated at least 1 to 10 times, preferably 6 times and subsequently separating the solid step by centrifugation. Preferably, the washing water containing residues of the process solvent is used in the following step B.

It must be noted that, in both cases, wherein silica is present or not, cellulose is purified with respect to the initial lignocellulosic biomass from amorphous substances contained in the biomass, preferably lignin, hemicellulose, SiO₂. The purification degree is expressed as cellulose crystallinity increase with respect to the initial biomass. Crystallinity is measured by X-ray powder diffraction. In particular, the cellulose has an increased degree of crystallinity, if compared to the initial biomass, comprised between 5% and 30% preferably between 7% and 23%.

In other words, the of cellulose purity increase in the process according to the present invention can be related to a more efficient separation of cellulose from other cellulosic materials such as lignin and hemicellulose.

The step B. of the process according to the present invention provides adding a quantity of water preferably in volumetric ratios with respect to the process solvent comprised between 15:1 and 3:1, preferably at room temperature, to the mixture containing the process solvent, lignin and hemicellulose so as to promote the lignin precipitation. In particular, the step B. following the addition of water, provides for the separation of lignin from the mixture by means of precipitation with conventional techniques, preferably, by centrifugation. Water used in step B., according to a preferred embodiment of the process, comes in part from at least steps E. or F.

Preferably, the process according to an embodiment of the present invention comprises a step G., which provides for the removal of water from the mixture coming from step B. by evaporation at low pressures, comprised between 1 bar and 20 mbars, preferably 10 mbars. Water is recycled in step E. or F. of the process for washing cellulose.

Probably, the step C of the process, according to the present invention, provides the addition of a quantity of a polar solvent, preferably a protic polar solvent, still more preferably a linear or branched aliphatic alcohol C₁-C₆, most preferably ethanol in volumetric ratios comprised between 10:1 and 1:1, preferably between 5:1 and 1:1, mostly 3:1 so as to promote precipitation of hemicellulose. In particular, the step C., following the addition of ethanol, provides for the separation of the hemicellulose from the mixture by precipitation with conventional techniques, preferably, by centrifugation.

According to an embodiment of the present invention the process can be carried out without step G. In this case, the mixture, coming from step B. contains water. The organic solvent, preferably ethanol, added to the aqueous mixture promotes precipitation of the hemicellulose and the subsequent separation of the process solvent, water and organic solvent.

According to an additional embodiment of the present invention in presence of the step G., the aqueous mixture coming from step B. is treated to remove the water contained therein. In this case, the organic solvent, preferably ethanol, added to the mixture coming from step G. promotes precipitation of the hemicellulose, contained in the mixture solubilizing it, and the subsequent separation of the process solvent and organic solvent.

Preferably, the process according to the present invention comprises a step D. of separating the process solvent, the organic solvent and possibly the water. In case the process does not comprise the step G. the separation step D. separates the mixture, coming from step C., into the single components, process solvent, water and organic solvent by fractional distillation. Thereby, it is possible to recycle the process solvent, water and organic solvent respectively in steps A., B. and C. On the contrary, in case the process comprises the step G., the separation step D separates the mixture, obtained in step C., into the single components of the process solvent and organic solvent by evaporation at low pressures, preferably comprised between 1 bar and 20 mbars, preferably 10 mbars. Thereby, it is possible to recycle the process solvent and organic solvent respectively in step A. and C.

In case the process solvent only contains ionic liquid or a mixture of DES and ionic liquid, also the recycled process solvent will contain ionic liquid or a combination of ionic liquid and DES. If necessary, the process can provide for the addition of a quantity of ionic liquid or of a mixture thereof of DES and ionic liquid to the process solvent recycled at step A.

Advantageously, recycling the process solvent, water and ethanol reduces the costs of materials and the environmental impact of the process according to the invention.

Hereinafter laboratory examples are reported in order to better explain the different process steps according to the invention and the high added-value products obtained.

### EXAMPLE 1

In this example 150 mg of husk as biomass and 1.5 g of DES choline acetate combined with glycolic acid, in a molar ratio 1:1 were used.

Step A:
preparation of 150 mg of ground husk with a granulometry lower than or equal to 0.25 mm
mixing of DES with husk for 15 h at 80° C.;
centrifugation of the mixture and obtaining a precipitate of cellulose and silica of 125 mg and a mixture of DES, hemicellulose and lignin.

Step E:
washing of the precipitate for six times with water at room temperature, the mixture containing water and DES is used in the process step B;
centrifugation of the aqueous mixture;
separation of silica from the cellulose which has a 7% increase in crystallinity if compared to the initial lignocellulosic biomass.

Step B:
addition of 10 ml of water to the mixture containing DES, lignin and hemicellulose;
centrifugation of the aqueous mixture;
separation of lignin in a quantity of 9 mg and obtaining a mixture containing DES, water and hemicellulose.

Step G:
Removal at low pressure (10 mbars) of water from the mixture from step B.

Step C:
mixing of 4.5 ml of ethanol to the mixture of DES and hemicellulose obtained from step B;
precipitation of the hemicellulose from the mixture;
centrifugation of the mixture;
separation of hemicellulose and relative recovery in a quantity of 5 mg.

Step D:
evaporation at low pressure of the mixture containing DES and ethanol obtained in step C;
separation of DES in a quantity equal to 1.1 g and ethanol.

### EXAMPLE 2

In this example 150 mg as biomass of husk and 1.5 g of choline acetate DES combined with levulinic acid, in a molar ratio 1:1 were used.

Step A:
preparation of 150 mg of ground husk with a granulometry lower than or equal to 0.25 mm
mixing of DES with husk for 24 h at 80° C.;
centrifugation of the mixture and obtaining a precipitate of cellulose and silica and a mixture of DES, hemicellulose and lignin.

Step E:
washing the precipitate for six times with water at room temperature, the mixture containing water and DES is used in step B of the process;
centrifugation of the aqueous mixture;
separation of silica from cellulose, which has a 6% increase in crystallinity degree if compared to the initial biomass.

Step B:
addition of 10 ml of water to the mixture containing DES, lignin and hemicellulose;
centrifugation of the aqueous mixture;
separation of the lignin and obtaining a mixture containing DES, water and hemicellulose.

Step G:
Removal at low pressure (10 mbar) of water from the mixture coming from step B.

Step C:
mixing of 4.5 ml of ethanol to the DES and hemicellulose mixture obtained from step B;
precipitation of the hemicellulose from the mixture;
centrifugation of the mixture
separation of a certain quantity of hemicellulose.

Step D:
evaporation at low pressure of the mixture containing DES and ethanol obtained in step C;
separation of DES and ethanol.

### EXAMPLE 3

In this example 150 mg of thistle as biomass and 1.5 g of choline acetate DES combined with glycolic acid, in a molar ratio 1 to 1 were used.

Step A:
preparation of 150 mg of dried thistle which is ground
mixing of DES with the thistle for 2 h and 30 minutes at 80° C.;
centrifugation of the mixture and obtaining a precipitate of cellulose and a mixture of DES, hemicellulose and lignin.

Step F:
washing of the cellulose precipitate for six times with water at room temperature, the mixture containing water and DES is used in the step B of the process;
centrifugation of the aqueous mixture;
separation of the cellulose from the aqueous mixture, obtaining a cellulose with a 19% increase in crystallinity degree if compared to the initial biomass.

Step B:
addition of 10 ml of water to the mixture containing DES, lignin and hemicellulose;
centrifugation of the aqueous mixture;
separation of lignin and obtaining a mixture containing DES, water and hemicellulose.

Step G:
Removal at low pressure (10 mbars) of water from the mixture from step B.

Step C:
mixing of 4 ml of ethanol to the mixture of DES, water and hemicellulose obtained from step B;
precipitation of the hemicellulose from the mixture;
centrifugation of the mixture;
separation of hemicellulose;

Step D:
evaporation at low pressure of the mixture containing DES and ethanol obtained in step C;
separation of DES

### EXAMPLE 4

In this example 150 mg of biomass from beer processing wastes (brewers spent grain) and 1.5 g of choline acetate DES combined with glycolic acid in a molar ratio 1 to 1 were used.

Step A:
preparation of 150 mg of dried and ground brewers spent grain
mixing of DES with brewers spent grain for 20 h at 80° C.;
centrifugation of the mixture and obtaining a precipitate of cellulose and a mixture of DES, hemicellulose and lignin.

Step F:
washing of the cellulose precipitate for six times with water at room temperature, the mixture containing water and DES is used in step B of the process;
centrifugation of the aqueous mixture;
separation of the cellulose from the aqueous mixture obtaining a cellulose with a 23% increase in crystallinity degree if compared to the initial biomass.

Step B:
addition of a certain quantity of water of 10 ml to the mixture containing DES, lignin and hemicellulose;
centrifugation of the aqueous mixture;
separation of lignin and obtaining a mixture containing DES, water and hemicellulose.

Step G:
Removal at low pressure (10 mbar) of water from the mixture coming from step B.

Step C:
mixing of a certain quantity equal to 4 ml of ethanol to the mixture of DES and hemicellulose obtained from step B;
precipitation of the hemicellulose from the mixture;
centrifugation of the mixture;
separation of a certain quantity of hemicellulose;

Step D:
evaporation at low pressure of the mixture containing DES and ethanol obtained in step C;
separation of DES

### EXAMPLE 5

In this example 150 mg of thistle as biomass and 1.5 g of choline acetate solvent as ionic solvent were used.

Step A:
preparation of 150 mg of dried thistle which is ground
mixing of the solvent with the thistle for 2 h and 30 minutes at 80° C.;
centrifugation of the mixture and obtaining a cellulose precipitate and a mixture of choline glycolate solvent, hemicellulose and lignin.

Step F:
washing of the cellulose precipitate for six times with water at room temperature, the mixture containing water and choline glycolate is used in the step B of the process;
centrifugation of the aqueous mixture;
separation of the cellulose from the aqueous mixture, obtaining a cellulose with a 23% increase in crystallinity degree if compared to the initial biomass.

Step B:
addition of 10 ml of water to the mixture containing choline glycolate, lignin and hemicellulose;
centrifugation of the aqueous mixture;
separation of lignin and obtaining a mixture containing choline glycolate water and hemicellulose.

Step G:
Removal at low pressure (10 mbars) of water from the mixture from step B.

Step C:
mixing of 4 ml of ethanol to the mixture of choline glycolate, water and hemicellulose obtained from step B;
precipitation of the hemicellulose from the mixture;
centrifugation of the mixture;
separation of hemicellulose;

Step D:
evaporation at low pressure of the mixture containing choline glycolate and ethanol obtained in step C;
separation of the solvent

### BIBLIOGRAPHY

### [1] R. Abejón, H. Pérez-Acebo, L. Clavijo, Processes 2018, 6, 98.

[2] J. Wu, A. Elliston, G. Le Gall, I. J. Colquhoun, S. R. A. Collins, I. P. Wood, J. Dicks, I. N. Roberts, K. W. Waldron, Biotechnol. Biofuels 2018, 11, 62.

### [3] L. Ludueña, D. Fasce, V. A. Alvarez, P. M. Stefani, BioResources 2011, 6, 1440-1453.

[4] M. C. Fernandes, M. D. Ferro, A. F. C. Paulino, J. A. S. Mendes, J. Gravitis, D. V. Evtuguin, A. M. R. B. Xavier, Bioresour. Technol. 2015, 186, 309-315.

[5] A. A. Shatalov, H. Pereira, Chem. Eng. Res. Des. 2014, 92, 2640-2648.

[6] S. Aliyu, Bala, African J. Biotechnol. 2008, 10, 324-331.

[7] P. K. Mishra, T. Gregor, R. Wimmer, BioResources 2017, 12, 107-116.

1. A process for treatment of lignocellulosic biomasses with a process solvent selected from an eutectic solvent consisting of a hydrogen bond acceptor and of a hydrogen bond donor, an ionic liquid and a mixture of the eutectic solvent and the ionic liquid, the process comprising:
A. mixing the biomasses with the process solvent and possibly separating insoluble cellulose residues and/or inorganic material;
B. treating the possibly filtered process solvent solution from step A with water thereby separating lignin; and
C. separating hemicellulose from the mixture of the process solvent and possibly the water;
wherein step C is carried out by adding an organic solvent soluble in the process solvent and in the water, whereby hemicellulose precipitates and is subsequently separated with conventional techniques from a liquid phase comprising the process solvent, the organic solvent and possibly the water.

2. The process of claim 1, further comprising:
D. separating, by fractional distillation and/or evaporation at low pressures, the liquid phase obtained in step C into individual components of the process solvent, the organic solvent, and possibly the water, which are recycled.

3. The process of claim 1, wherein the hydrogen bond acceptor and the hydrogen bond donor are halogen-free,
wherein the hydrogen bond acceptor is choline acetate, and
wherein the hydrogen bond donor is selected from: glycolic acid, diglycolic acid, levulinic acid, and imidazole.

4. The process of claim 1, wherein the ionic liquid means the product resulting from a reaction of:
choline acetate+X—H=choline X⁻+CH₃COOH
where X is an anion of an organic weak acid selected from glycolic acid, diglycolic acid, and levulinic acid.

5. The process of claim 1, wherein the mixture of the eutectic solvent and the ionic liquid comprises:
as the ionic liquid: choline X⁻ and acetic acid, where X⁻ is an anion of an organic weak acid selected from glycolic acid, diglycolic acid, and levulinic acid; and
as the eutectic solvent: a hydrogen bond acceptor and a hydrogen bond donor being halogen-free, wherein the hydrogen bond acceptor is choline acetate, and wherein the hydrogen bond donor is selected from: glycolic acid, diglycolic acid, levulinic acid, and imidazole.

6. The process of claim 3, wherein the weight ratio between the hydrogen bond acceptors and the hydrogen bond donors of the halogen-free eutectic solvent is greater than or equal to 1:5 and less than or equal to 5:1.

7. The process of claim 1, wherein the biomasses come from rice, thistle, or threshing processing waste.

8. The process of claim 7, wherein the rice processing waste is selected between husk and straw, and
wherein step A comprises separating silica and cellulose from the solution containing the process solvent.

9. The process of claim 8, further comprising:
E. separating the cellulose and the silica by precipitation in water.

10. The process for the treatment of biomasses according to of claim 7, wherein when the processing waste comes from thistle or straw, step A provides for the separation of the cellulose from the solution containing the process solvent.

11. The process of claim 10, further comprising:
F. washing the process solvent with water to remove cellulose from the process solvent and the cellulose is separated from water.

12. The process of claim 1, wherein the mixing temperature of the process solvent in step A is greater than or equal to 40° C. and less than or equal to 100° C.

13. The process of claim 1, wherein the water-soluble organic solvent is a C₁-C₆ linear or branched aliphatic alcohol.

14. The process of claim 4, wherein the hydrogen bond donor is selected from glycolic acid or levulinic acid.

15. The process of claim 5, wherein the hydrogen bond donor is selected from glycolic acid or levulinic acid.

16. The process of claim 6, wherein the weight ratio is greater than or equal to 1:3 and less than or equal to 3:1.

17. The process of claim 6, wherein the weight ratio is greater than or equal to 1:2 and less than or equal to 2:1.

18. The process of claim 6, wherein the weight ratio is 1:1.

19. The process of claim 12, wherein the mixing temperature is greater than or equal to 60° C. and less than or equal to 90° C.

20. The process of claim 12, wherein the mixing temperature is greater than or equal to 70° C. and less than or equal to 85° C.

21. The process of claim 12, wherein the mixing temperature is 80° C.

22. The process of claim 13, wherein the C₁-C₆ linear or branched aliphatic alcohol is ethanol.
